(19) United States
(12) Patent Application Publication
(10) Pub. No.: US 2002/0070940 A1
(43) Pub. Date: Jun. 13, 2002

(54) Method and apparatus for controlling interactivity of elements in a video sequence

(75) Inventors: Tilman Hampl, Waldbuttelbrunn (DE); Winfried Piegsda, Eggenstein-Leopoldshafen (DE); Ralph Sonntag, Kunzell (DE)

Correspondence Address: MICHAEL BEST & FRIEDRICH, LLP, 100 E WISCONSIN AVENUE, MILWAUKEE, WI, 53202, US

(73) Assignee: active-film.com AG, Frankfurt am Main (DE)

(21) Appl. No.: 09/930,370

(22) Filed: Aug. 15, 2001

(30) Foreign Application Priority Data
Aug. 16, 2000 (EP) 00117656.9

(51) Int. Cl. G06T 13/00; G06T 15/70

(52) U.S. Cl. 345/473

(57) ABSTRACT

A method for computer based controlling of interactivity of elements in a video sequence in which a video sequence is reproduced, an action of a viewing person influences the progress or display of the video sequence and depending on the action of the viewing person, the activatability of activatable

### BACKGROUND OF THE INVENTION

1. Field of the Invention

The invention relates to a method and an apparatus for controlling interactivity of elements in a video sequence according to the preamble part of claim 1.

2. Description of the Related Prior Art

The general need to provide information to a customer in a simple and attractive manner, the increasing propagation of different reproduction platforms for video sequences and the customer's desire to determine the received information himself, interactivity in video sequences becomes a major means for providing information.

FIG. 1 illustrates a basic principle of creating interactivity for elements 11, 12 or 15 of a video sequence 10. The video sequence 10 comprises for example a picture sequence 13 and an audio sequence 14. In means 20 for creating the interactivity activation properties 21 and 22 as well as activatable objects 31 and (12+22) are created for the elements 11 and 12. The activatable objects 31, (12+22) are incorporated into the video sequence 10 to provide interactivity in a reproduction platform 30. Therein, the picture sequence 13, with said activatable objects 31 and the activatable area 22, is displayed in a display unit 33 and the audio sequence 14 is reproduced as a sound sequence 12 by means of the audio reproduction unit 34. A non-illustrated viewing person can activate the activatable objects 31 or (12+22) by actions with a pointing unit 35. The activation properties 21,22 may comprise different events for various actions of the viewing person. If the viewing person by means of the pointing unit 35 points to the activatable object 31, an informative text may be displayed. If the viewing person upon pointing presses a button on the pointing unit 35, a short non-illustrated video sequence comprising further activatable objects may be displayed, after its end the video sequence 10 may be continued.

As illustrated in FIG. 1 the elements of the video sequence 10 may be visual (building 11) or auditive (sound sequence 12) or even content related (e.g. happiness or friendship) elements.

FIG. 6 illustrates a video sequence reproduced according to the prior art without an action of a non-illustrated viewing person. An axis of the frame numbers 40 and a time axis 50 indicate the progress of the video sequence 10. The element 11 becomes activatable in the frames 5 and 6 by means of the activatable object 31. The element 12 is activatable via the activatable area 22 in frames 2-4.

FIG. 5 illustrates a video sequence 10 reproduced according to the prior art wherein an action 80 of a non-illustrated viewing person regarding an activatable area 22 is answered by inserting a video sequence 70. The axes of frame numbers 40 and 60 as well as the time axis 50 indicate the progress of the video sequences 10 and 70. The element 11 becomes activatable in the frames 5 and 6 by means of the activatable objects 31. The element 12 is activatable via the activatable area 22 and is activated in picture 3. The video sequence 70 comprises a picture sequence 73 and an audio sequence 74 and is reproduced with its elements 71 and 72. Thereafter reproduction of the video sequence 10 is continued.

Interactivity in video sequences is affected with several problems. For example, a viewing person may need longer than an average viewing person to identify and activate visual activatable objects and contrary thereto may recognise auditive elements faster than commonly usual. In a common video sequence having activatable objects, this viewing person from the activatable objects will activate auditive objects frequently often, visual objects sometimes and moving visual objects rarely.

Furthermore, for the viewing person contrary to his interests, always the same widespread information in form of activatable objects is presented, and the viewing person has to search this information according to his interests.

### SUMMARY OF THE INVENTION

It is the object of the present invention to provide interactivity in video sequences in such a way, that an improved usability relative to offered information and information presentation is achieved.

This object according to the invention is solved by a method according to claim 1. The dependent claims describe preferred embodiments of the invention.

According to the invention, a video sequence is reproduced and an action of a viewing person is processed, which influences presentation or progress of the video sequence, for then controlling an activatability of activatable objects in video sequences depending on said action of the viewing person. The advantage of this solution is that an offered information becomes adaptable for a viewing person by taking into account either specific individual capabilities of the viewing person to interact with his reproduction platform or the viewing person's previous actions related to video sequences comprising activatable objects. For example, an information may be presented to the viewing person never again, only on its own or repeatedly.

According to a preferred embodiment of the method, the activatability of the activatable objects is controlled in the video sequence for which the action has been performed. Thereby an adaption of the offered information to a present behaviour of the viewing person can be achieved. Such an adaption for example does makes sense, if the viewing person by his actions indicates a new and possibly temporary area of interest.

It is particularly advantageous to store the action of the viewing person for protocolling it, to thereby keep the protocolled action available as information for a later time. Thereby protocolled actions may be collected and statistical analysis performed to analyse the interests, habits and capabilities of the viewing person in more detail.

In a further preferred embodiment of the method, the protocolled actions is used to control activatability of activatable objects in video sequences reproduced after said protocolled reproduction. For a repeated reproduction of the video sequence, for which no actions of the viewing person have been protocolled during first reproduction, the activatability period for example may be extended to offer improved activation possibilities to the viewing person.

According to a preferred embodiment of the method, the action of a viewing person is stored at a viewing person's side or associated to the viewing person at a provider of said video sequence. The analysis of the protocolled actions and the controlling of the activatability can be performed locally or the provider may adapt a new video sequence for the viewing person to his previous actions.

It is particularly advantageous to store the action at a reproduction platform associated to a group of viewing persons or at a provider of the video sequence associated to the reproduction platform or to the group of viewing persons, if said reproduction platform is used by more than one viewing person. The reproduction platform typically will be used by a group of viewing persons having specific interests, which then may be considered accordingly.

According to an embodiment of the method, an activation property of activatable objects in said video sequences is controlled depending on the viewing person's action, whereby for example the size, position or colour of the representative, an activatable element may be changed to adapt the activatable object to the action of the viewing person.

According to a further preferred embodiment of the method, the realisation of the above-mentioned method is achieved by means of the programming features of the software QuickTime. Thereby no additional software has to be used at a viewing person's side for achieving protocolling or controlling of the activatability.

According to a further embodiment of the method, a computer controlled apparatus is used to realise one of the prescribed methods, whereby short processing times and an optimised embodiment of the method becomes possible.

According to a further embodiment, a storage medium comprises a computer programme or an instruction sequence realising one of the prescribed methods. By this embodiment, a once implemented method becomes usable repeatedly and transportable.

### BRIEF DESCRIPTION OF THE DRAWINGS

The enclosed Figures illustrate:

FIG. 1 A basic principle for creation of interactivity of elements in a video sequence,

FIG. 2 A representation of the progress of a video sequence having activatable objects upon a viewing person's actions according to the invention,

FIG. 3 A representation of the dependency of an element's activatability from the viewing person's actions in three cases according to the invention,

FIG. 4 A representation of the dependency of another element's activatability from a viewing person's actions in three cases according to the invention,

FIG. 5 A representation of the common progress of a video sequence upon a viewing person's action,

FIG. 6 A representation of the common progress of a video sequence without a viewing person's action,

FIG. 7 A representation of the common activatability of an element according to the prior art.

### DETAILED DESCRIPTION OF THE INVENTION

In the following, the invention is described with reference to the accompanying figures for preferred embodiments of the invention.

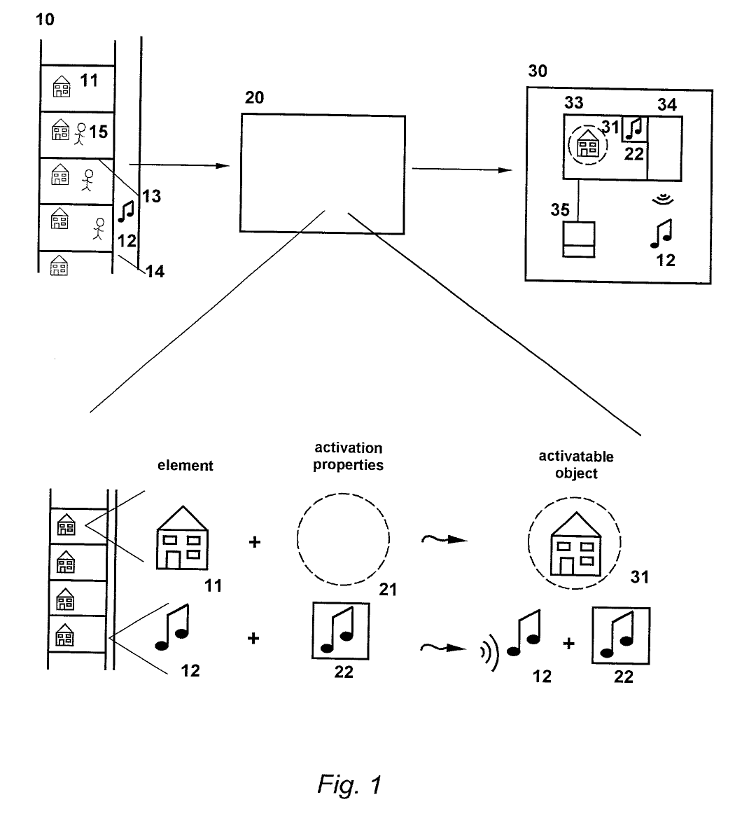

The video sequence 10 illustrated in FIG. 1 may be produced by digitising a picture and audio sequence and a following compression. The progress of the video sequence particularly may be controlled by a viewing person by:

stopping, zooming, forward or rewinding with or without reproduction, and activation of activatable objects in the video sequence.

The reproduction platform 30 illustrated in FIG. 1 for example may be a computer, a mobile phone, a television having corresponding properties or a television in combination with a video recorder. A computer particularly may comprise the following: a display unit, a keyboard, a pointing unit, a controlling unit, a hard disk and a drive for optical or magnetical storage media. Further, the computer may be supplemented by the following units: a modem, a microphone, a loudspeaker and a digital camera. Means for providing or controlling interactivity for the video sequence 10 may arrive at the reproduction platform 30 together with said video sequence 10 or already be comprised therein, for example in the software for reproduction of the video sequence 10 or separated in a software for provision and another one for administration of interactivity.

The reproduction platform 30 may comprise different hard- or software components. Even upon identical components, they may differ in their behaviour, by being worn out, dysfunction or additional parallel usage. The activation of activatable objects thereby may proceed in different speeds. If for example a certain key on the keyboard of the viewing person is defect and reacts only to each second or third pressing of the key, then the activation of the associated activatable objects will be delayed.

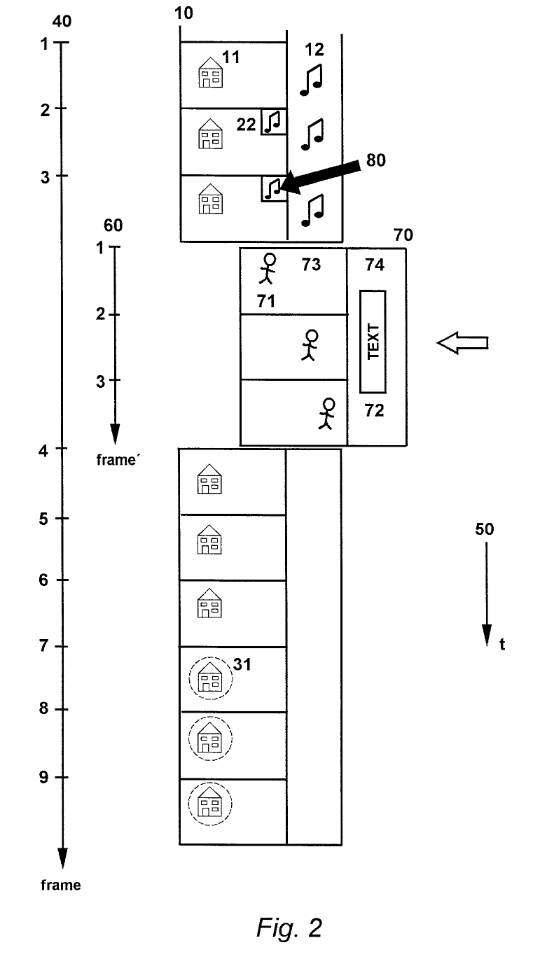

FIG. 2 illustrates a video sequence 10 reproduced in a reproduction platform with its elements 11 and 12 in its progress in time. Therein, a viewing person's action 80 is illustrated for frame number 3 of the video sequence 10. The axes of the frame numbers 40 and 60 as well as the time axis 50 indicate the progress of the video sequences 10 and 70. The element 12 becomes activatable in frames 2 and 3 by means of the activatable area 22. A non-illustrated viewing person activates the activatable area 22 in frame 3. This action 80 of the viewing person leads to insertion of a video sequence 70 comprising a picture sequence 73 and an audio sequence 74 as well as elements 71 and 72. After the last frame of the video sequence 70, the video sequence 10 is continued with its frame 4. Because the activatable area 22 has been already activated in frame 3, it is not displayed in frame 4 anymore. Furthermore, the element 11 becomes activatable by its activatable object 31 in frame 7 at first. Thereby, a time period after the end of the video sequence 70 is provided to the viewing person for concentrating again on the video sequence 10, before offering new activatable objects to him. The chances for an activation of the activatable object 31 thus can be improved.

For demonstrating a method according to the invention, in the following we assume the video sequence 10 to be a commercial video for the music shop 11 which wants to sell a plurality of music titles. The activatable area 22 of the music title 12 is activated by the action 80 of a viewing person to illustrate a singer 71 and his career 72 in a video sequence 70. Should the viewing person replay the same video sequence a second time, preferably music titles of a similar music type as the music title 12 are presented to him by analysing the protocolled action 80 and corresponding controlling of the activatability of activatable objects in the video sequence 10. If the viewing person replays a part of the video sequence 10 with increased reproduction speed or even skips this part, then for example the activatability of the following major elements may be extended, at the same time the representative of these elements may be enlarged or emphasised and the less important elements may be made nonactivatable.

Possible activation properties of an activatable element are for example:

the events redeemed by different actions of the viewing person (for example a new video sequence, text display or building up a connection to the Internet),

the different actions of the viewing person, which lead to an activation of the element,

the representative for the activatable element in its form, positional arrangement, colour and size.

In a preferred embodiment, the action 80 of the viewing person is for example locally and temporarily stored at the reproduction platform of the viewing person. In the reproduction platform, in a temporary storage, a statistic comprising the following data may be held:

a category counter for actions of the viewing person for activatable objects of different categories,

a time counter for the overall time of the reproduced video sequences,

a time stamp of the last action of the viewing person.

For this example, each activatable object is associated to one category (for example jazz, sole, pop, classic or rock). An event of the activatable objects started by an action of the viewing person increases the corresponding category counter, increases the time counter, based on the difference to the last time stamp, and resets the time stamp according to the lapsed time in the video sequence. At the end of the video sequence, an automatically started event increases the time counter and resets the time stamp to zero. In a preferred embodiment of the method, the following data may be derived if desired or either stored and recalculated with each event:

an activation factor calculated from the sum of the category counters divided through the time counter,

a target category derived from the maximum of the category counters.

Based on the target category and the activation factor for example a starting value for a video sequence to be reproduced, can be determined. The starting value determines a category dependent activatability of activatable objects in the video sequence, therein initially an equally distributed activatability is set and upon existing target category a weighted activatability of the activatable objects of the category in the video sequence is set accordingly. The existence of a target category may be bound to conditions e.g. a critical value for a minimum activation factor, a minimum for the portion of the target category counter in the sum of all category counters. This embodiment simply may be extended by using more than one target category, more complex conditions and particularly dividing the video sequence in parts on which ends an evaluation of the counters is performed, to determine the starting value for the next part of the video sequence.

In a computer as a reproduction platform for example the software QuickTime may be used to display the video sequence. The software QuickTime offers a wide variety of programming features for example allowing to protocol an action of a viewing person and storing same in a database. Furthermore, for example activation properties or activatabilities in time of elements of a video sequence may be administered by means of these programming features, whereby also the controlling of the activatability of the activatable elements becomes possible.

In particular, in a database the following may be stored:

an identifier for the video sequence 10,

overall reproduction time for the video sequence 10,

an identifier for the activatable object 31,

a relative time of the activation in the video sequence 10, and

the type of activation.

The database forms the basis for administration of major and more complex data amounts, which may be evaluated for example in parallel to the above-described temporary evaluation, or evaluated internally separated in short time and long time data. By storing and evaluating the activation type for example the above-described defect key of the reproduction platform 30 could be identified as a potential problem and avoided by correspondingly controlling activation properties in video sequences.

The viewing person for example may be a consumer of the video sequence 10 or a consumer group thereof. A reproduction platform 30 may be used by different viewing persons for example by a group of viewing persons, wherein separation of the viewing persons is not necessary, but possible for example by means of authentication. The viewing person group may have preferably the same interests, for example caused by the positional arrangement of the reproduction platform in a specific shop. For the reproduction platform 30, for example locally at the reproduction platform, the action 80 of the viewing person is protocolled to control the activatability of activatable objects for the group of viewing persons. On the other hand, a provider may also internally administer the actions of a viewing person group, independent from the common use of a reproduction platform if he defines respective criteria for groups of viewing persons.

The provider may read out and centrally evaluate the protocolled data of the reproduction platform in said specific shop, for example month by month. If the protocolled action 80 is stored in a database at a provider of the video sequence 10 and associated to a viewing person, a reproduction platform or a group of viewing persons, then the provider may for a following request for a video sequence by the viewing person, the reproduction platform or the group of viewing persons create a personalised video sequence or adapt the activatability of activatable objects in the video sequence to the protocolled actions. The protocolled actions can be provided to the provider together with the request for the next video sequence via the Internet, wherein the video sequence is provided to the viewing person over the Internet.

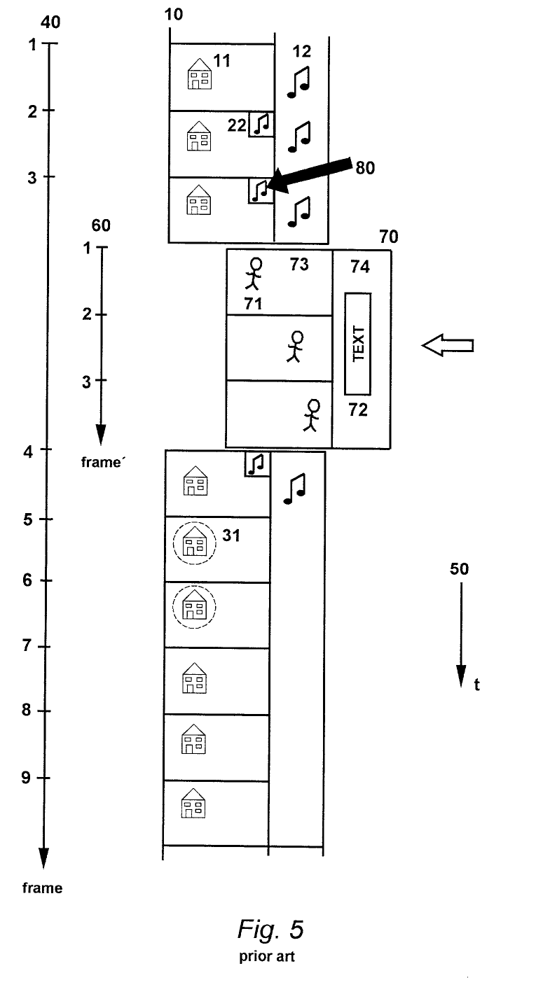

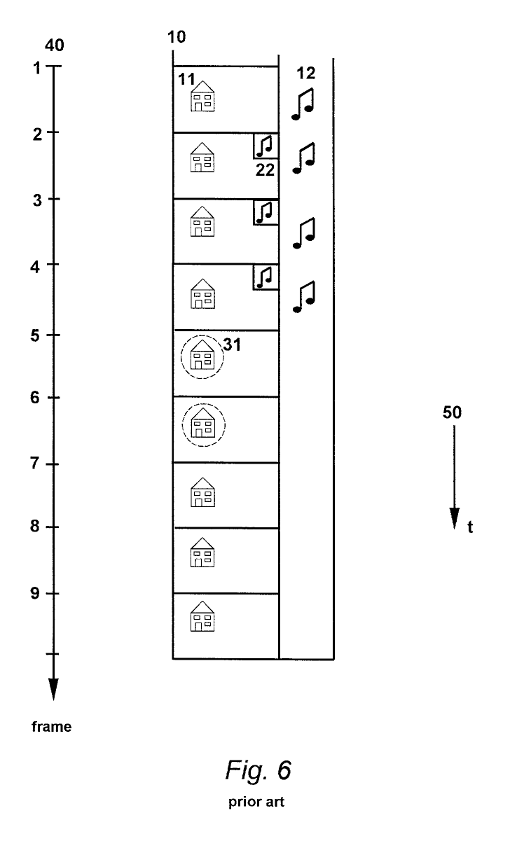

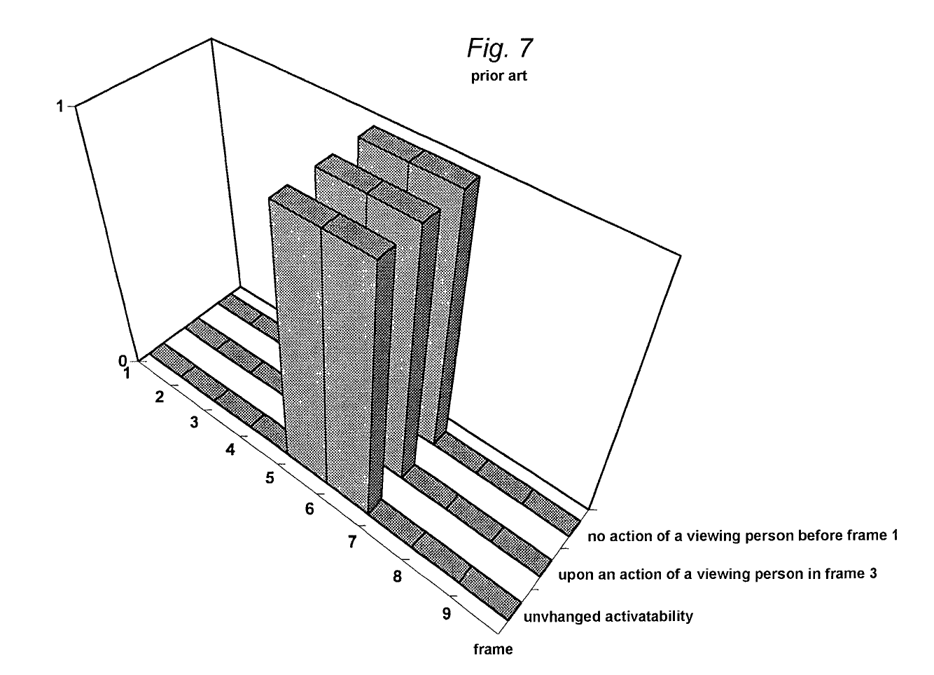

As illustrated in FIG. 7, the activatability of element 11 from FIGS. 5 and 6 according to the prior art is independent from actions of the viewing person. FIG. 7 illustrates the activatability of element 11 in relation to the frame number of the video sequence 10 for three cases:

unchanged activatability; without an action of a viewing person as illustrated in FIG. 6,

upon an action 80 of the viewing person in frame 3 of the video sequence 10 as illustrated in FIG. 5, and

without an action of the viewing person before frame 1 of the video sequence 10.

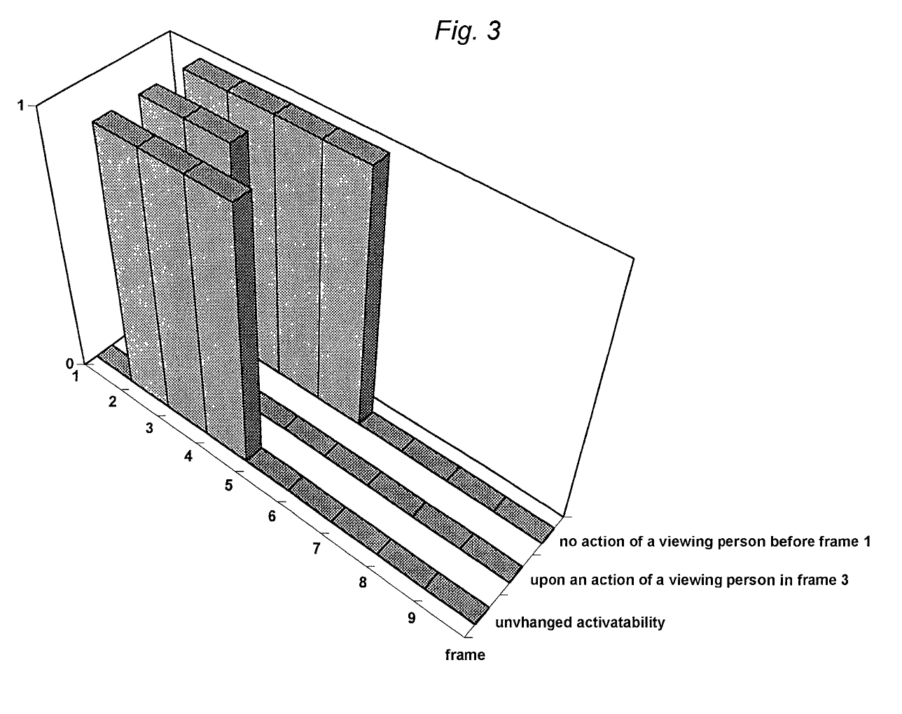

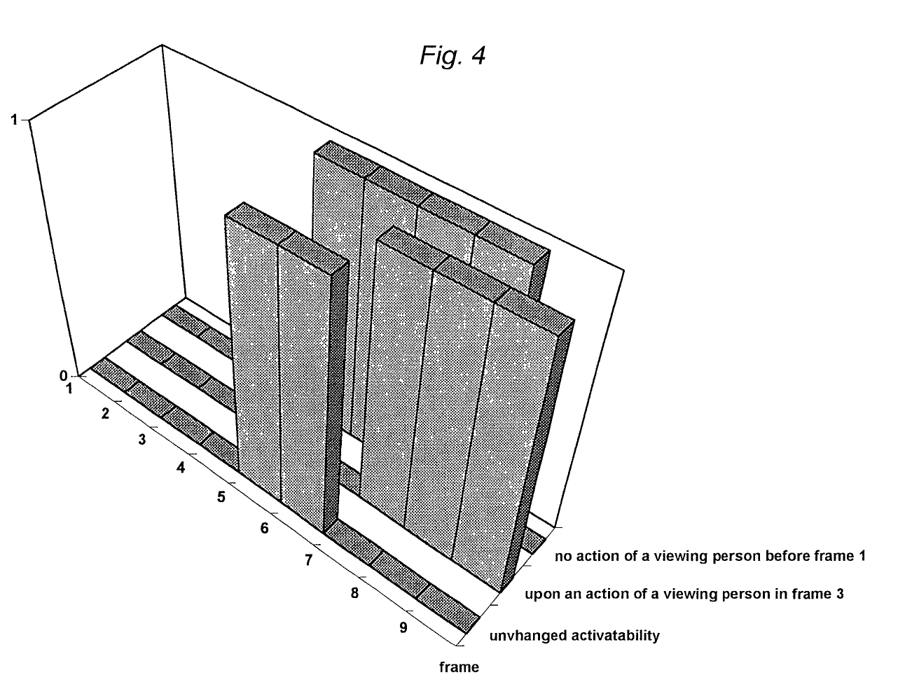

According to the invention the activatability of an activatable object will be controlled dependent on an action of the viewing person, as exemplary illustrated in FIGS. 3 and 4. FIG. 3 shows the activatability of element 12 in relation to the frame number for the three cases of FIG. 7. The unchanged activatability of element 12 illustrates that the activatable area 22 is displayed in frames 2, 3 and 4 (see FIG. 6). As illustrated in FIG. 3, if an action 80 of the viewing person takes place in frame 3 of the video sequence (see FIG. 2), the activatability of element 12 is given in frames 2 and 3 only. If to the contrary neither in frame 3 nor before frame 1 of the video sequence 10 took place, then for example the activatability of the activatable area 22 is extended by one frame, to allow a longer reaction time for the viewing person.

Similar to FIG. 3, FIG. 4 illustrates the activatability of element 11 in relation to the frame number for the above three cases. The case of unchanged activatability shows for frames 5 and 6 an activatability of the element 11. Upon an action of a viewing person in frame 3, according to FIG. 2, the activatability is moved and at the same time extended to frames 7, 8 and 9. The third case again illustrates the controlled activatability of element 11, if neither before frame 1 nor in frame 3 an action of a viewing person took place. The activatability period for element 11 for example is extended to consider a slow reaction of the viewing person or any problems of the viewing person upon using his reproduction platform.

A computer controlled apparatus comprising means to realise the prescribed methods for example can be a computer, a mobile phone, a television having corresponding properties or a television in combination with a video recorder.

A computer programme implementing the prescribed methods may be stored on a hard disk of a computer or a magnetical or optical data storage medium.

What is claimed is:

1. A method for computer based controlling of activatable objects in video sequences, comprising:
reproducing a video sequence;
processing an action of a viewing person which has an influence to progress or display of the video sequence;
characterised by:
controlling the activatability of said activatable objects in said video sequences depending on the action of said viewing person.

2. The method according to claim 1, characterised in that the activatability of activatable objects is controlled in said video sequence, for which the action took place.

3. The method according to claim 1, characterised by storing the action for protocolling it.

4. The method according to claim 3, characterised in that the protocolled action is used for controlling activatability of activatable objects in video sequences, reproduced after said protocolled reproduction.

5. The method according to claim 3, characterised in that the action is stored at the viewing person's side or associated to said viewing person at the provider of said video sequence.

6. The method according to claim 3, characterised in that the action is stored at the reproduction platform associated to a group of viewing persons or at a provider of said video sequence associated to said reproduction platform or to said group of viewing persons.

7. The method according to claim 1, characterised in that an activation property of the activatable objects is controlled in said video sequences depending on the viewing person's action.

8. The method according to claim 1, characterised in that the internal programming features of software QuickTime are used to realise the method.

9. A computer controlled apparatus comprising means realising a method according to claim 1.

10. A storage medium comprising a computer programme or an instruction sequence realising a method according to claim 1.
